(19) United States
(12) Patent Application Publication
(10) Pub. No.: US 2025/0371378 A1
(43) Pub. Date: Dec. 4, 2025

(54) METHOD, DEVICE AND MEDIUM FOR GENERATING TRAINING DATA OF MOBILE AGENT

(71) Applicant: BEIJING BAIDU NETCOM SCIENCE TECHNOLOGY CO., LTD., Beijing (CN)

(72) Inventors: Le ZHANG, Beijing (CN); Jingbo ZHOU, Beijing (CN)

(73) Assignee: BEIJING BAIDU NETCOM SCIENCE TECHNOLOGY CO., LTD., Beijing (CN)

(21) Appl. No.: 19/302,695

(22) Filed: Aug. 18, 2025

(30) Foreign Application Priority Data
Jun. 19, 2025 (CN) 202510827952.9

(51) Int. Cl. G06N 5/02

(52) U.S. Cl. CPC G06N 5/02

(57) ABSTRACT

A method for generating training data of a mobile agent relating to the technical field of artificial intelligence is provided. The method includes: collecting multiple data triples representing interaction behaviors in an application; each of the data triples including a first user interface state, an action, and a second user interface state; constructing a state transition graph based on the multiple data triples; obtaining an interaction trajectory based on the state transition graph; and generating training data of the mobile agent based on the interaction trajectory.

### CROSS-REFERENCE TO RELATED APPLICATION

The present disclosure claims the priority and benefit of Chinese Patent Application No. 202510827952.9, filed on Jun. 19, 2025. The disclosure of the above application is incorporated herein by reference in its entirety.

### TECHNICAL FIELD

The present disclosure relates to the field of computer technology, particularly to the technical field of artificial intelligence, and more particularly to a method, device and medium for generating training data of a mobile agent.

### BACKGROUND

In recent years, with the popularity of large vision-language models, using them to control mobile terminals to complete specific tasks and implement mobile agents has received increasing attention.

For training a mobile agent, the core challenge lies in the need for sufficient high-quality data. Currently, the most intuitive approach is to construct data manually. For example, first artificially setting some task objectives (such as: adding contacts), then having annotators perform a series of operations on real devices to complete the task objectives, thereby generating an operation trajectory for model training.

### SUMMARY

The present disclosure provides a method, device and medium for generating training data of a mobile agent.

According to an aspect of the present disclosure, a method for generating training data of a mobile agent is provided. The method includes:
collecting multiple data triples representing interaction behaviors in an application; each of the data triples including a first user interface state, an action, and a second user interface state;
constructing a state transition graph based on the multiple data triples;
obtaining an interaction trajectory based on the state transition graph; and
generating training data of the mobile agent based on the interaction trajectory.

According to another aspect of the present disclosure, an electronic device is provided. The electronic device includes:
at least one processor; and
a memory communicatively connected to the at least one processor; where
the memory stores instructions executable by the at least one processor to cause the at least one processor to perform the method as described in the above aspect and any possible implementation.

According to yet another aspect of the present disclosure, a non-transitory computer-readable storage medium storing computer instructions is provided, and the computer instructions are used to cause the computer to perform the method as described in the above aspect and any possible implementation.

It should be understood that the content described in this section is not intended to identify key or essential features of the embodiments of the present disclosure, nor is it intended to limit the scope of the present disclosure. Other features of the present disclosure will become readily understood through the following specification.

### BRIEF DESCRIPTION OF THE DRAWINGS

The drawings are used for better understanding the present solution and do not constitute a limitation of the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure; and

FIG. 5 is a block diagram of an electronic device for implementing the method of the embodiments of the present disclosure.

### DETAILED DESCRIPTION OF EMBODIMENTS

The following description of exemplary embodiments of the present disclosure is made with reference to the drawings, which includes various details of the embodiments to aid in understanding, and should be considered merely exemplary. Therefore, those skilled in the art should recognize that various changes and modifications can be made to the embodiments described herein without departing from the scope and spirit of the present disclosure. Similarly, descriptions of known functions and structures are omitted for clarity and conciseness.

It should be understood that the described embodiments are only part of the embodiments of the present disclosure, not all of them. All other embodiments obtained by those skilled in the art without creative effort based on the embodiments of the present disclosure shall fall within the protection scope of the present disclosure.

It should be noted that the terminal devices involved in the embodiments of the present disclosure may include but are not limited to mobile phones, Personal Digital Assistants (PDA), wireless handheld devices, Tablet Computers and other smart devices; display devices may include but are not limited to personal computers, televisions and other devices with display functions.

Additionally, the term “and/or” in this document is merely a description of associative relationships between associated objects, indicating that three relationships can exist. For example, A and/or B can indicate: A exists alone, both A and B exist simultaneously, or B exists alone. Furthermore, the character “/” in this document generally indicates an “or” relationship between the associated objects before and after it.

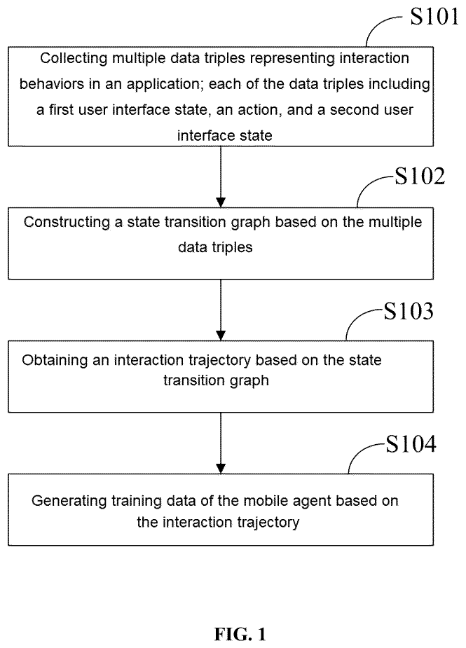

FIG. 1 is a schematic diagram according to a first embodiment of the present disclosure; as shown in FIG. 1, this embodiment provides a method for generating training data of a mobile agent, which may include the following steps:

S101: collecting multiple data triples representing interaction behaviors in an application; each of the data triples including a first user interface state, an action, and a second user interface state;

The execution subject of the method for constructing training data of the mobile agent in this embodiment may be an apparatus for constructing training data of the mobile agent, which may be an electronic entity, or may also be an application corresponding to software, capable of automatically constructing training data for the mobile agent.

In this embodiment, a mobile agent may refer to a large language model agent that may be deployed on mobile devices, possessing capabilities of image perception, interface understanding, operation decision-making, and task execution. The mobile agent collects screen visual information (such as screenshots), parses user interface elements, and simulates user operations (such as clicking or swiping) to complete task exploration or control objectives, having closed-loop intelligent control capabilities of perception-decision-execution.

A mobile agent may be considered as a super application (APP). For example, when a user is using a mobile device, he/she may make a request in the mobile agent, and the mobile agent will control the mobile device to automatically use multiple APPs to complete a task, such as booking a hotel, sending an email, etc.

Additionally, a mobile agent may be an intelligent assistant built into the Operating System (OS). For example, it may be a native agent in Windows, Android, iOS, and other mobile and PC operating systems. In the future, it may also be possible to download mobile agent super applications through APP stores or other channels.

Furthermore, a mobile agent may also be embedded in a third-party APP, where a user may directly give an instruction to the APP, and the APP will automatically complete a task, making it very convenient to use.

In this embodiment, for each data triple representing an interaction behavior, under the drive of the action in this data triple, the application can transition from the first user interface state to the second user interface state. The first user interface state and the second user interface state in this embodiment may refer to screenshots of two interfaces in the application respectively. Among them, the first user interface state may be denoted as pre_state, the second user interface state may be denoted as post_state; and the action may be denoted as action.

S102: constructing a state transition graph based on the multiple data triples;

In this embodiment, for each data triple, under the drive of action, the application can transition from pre_state to post_state, achieving one state transition. By taking pre_state and post_state in each data triple of the multiple data triples as nodes, and taking action in each data triple as a directed edge between pre_state and post_state, a state transition graph can be constructed. The post_state in a previous data triple among different data triples may be the pre_state in a subsequent data triple.

S103: obtaining an interaction trajectory based on the state transition graph; In this embodiment, the interaction trajectory obtained from the state transition graph may include a trajectory of at least one interaction behavior. That is, at least one data triple is included, or at least one action and two user interface states before and after that action are included. When the interaction trajectory includes two or more interaction behaviors, the two or more interaction behaviors must be continuous. For example, taking an interaction trajectory including two interaction behaviors as an example, the application may transition from a first user interface state U1 to a second user interface state U2 under the drive of action1; and further transition from the second user interface state U2 to a third user interface state U3 under the drive of action2. This interaction trajectory may be represented by a triple sequence including two triples, such as (U1, action1, U2), (U2, action2, U3). The same principle applies to obtaining interaction trajectories including more than two interaction behaviors. In this embodiment, multiple interaction trajectories can be obtained from the state transition graph in this way.

S104: generating training data of the mobile agent based on the interaction trajectory.

In this embodiment, for each interaction trajectory, a set of interaction behaviors can be simulated to generate a set of training data for the mobile agent.

In this embodiment, the generation of training data for the mobile agent is exemplified using one application. In practical applications, for multiple applications, a state transition graph corresponding to each application may be constructed, and multiple interaction trajectories may be obtained for each application, generating multiple corresponding training data for the mobile agent. Through the collection method of multiple applications, the types and content of training data for the mobile agent can be effectively enriched, thereby improving the training effect of the mobile agent.

The method for generating training data of the mobile agent in this embodiment can automatically collect multiple data triples representing interaction behaviors in an application, construct a state transition graph based on the collected data, then obtain an interaction trajectory, and generate training data for the mobile agent. This can implement the automatic generation of training data for the mobile agent without manual intervention throughout the process, saving labor costs, reducing manual operation errors, and effectively improving the accuracy and generation efficiency of the generation of training data for the mobile agent.

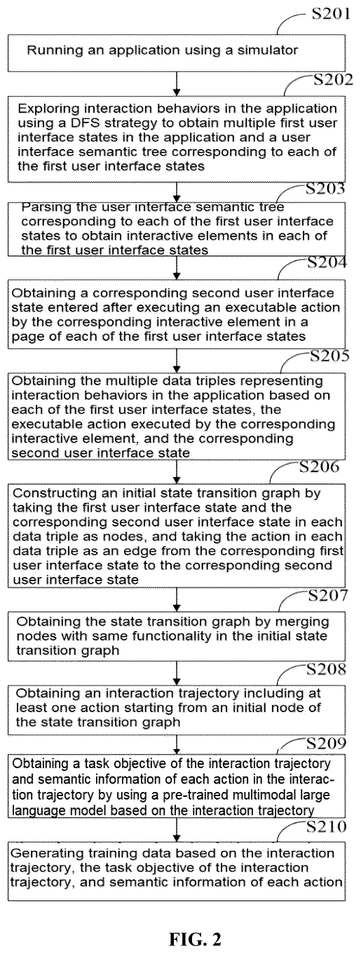

FIG. 2 is a schematic diagram according to a second embodiment of the present disclosure; the method for generating training data of the mobile agent in this embodiment, based on the technical solution of the embodiment shown in FIG. 1, further describes the technical solution of the present disclosure in more detail. As shown in FIG. 2, the method for generating training data of the mobile agent in this embodiment may specifically include the following steps:

S201: running an application using a simulator;

The application in this embodiment may include a system native application, or may include an application that a user can download through an APP store or other channels. The applications involved in this embodiment may be applications with high download frequency in APP stores, including lifestyle service applications, work processing applications, leisure and entertainment applications, etc.

S202: exploring interaction behaviors in the application using a Depth First Search (DFS) strategy to obtain multiple first user interface states in the application and a user interface semantic tree corresponding to each of the first user interface states;

In order to accurately collect data triples, in this embodiment, a simulator is used to simulate the running of the application.

In this embodiment, the DFS strategy explores interactions for a single APP, with the goal of covering as many operable User Interface (UI) elements, i.e., user interface states as possible, to generate rich interaction samples.

When running the application in the simulator, screen screenshots of each page can be obtained in real-time as a user interface state, and the Accessibility Tree, i.e., user interface semantic tree, corresponding to each page can be obtained.

The user interface semantic tree is a structured interface representation exposed by the operating system to Accessibility Services. It is a semantic abstraction of the Graphical User Interface (GUI) layer, describing the hierarchical structure, attribute information, and state information of all interactive elements in the interface.

S203: parsing the user interface semantic tree corresponding to each of the first user interface states to obtain interactive elements in each of the first user interface states;

For each page, all interactive elements are parsed from the corresponding Accessibility Tree, which may include buttons or input boxes, etc, for example.

S204: obtaining a corresponding second user interface state entered after executing an executable action by the corresponding interactive element in a page of each of the first user interface states;

S205: obtaining the multiple data triples representing interaction behaviors in the application based on each of the first user interface states, the executable action executed by the corresponding interactive element, and the corresponding second user interface state;

For each page, randomly select an interactive element and its executable action, after executing the action, enter a new UI state. The original page is pre_state, the executable action is action, and the entered new UI state is post_state. In this way, each interaction generates a data triple <pre_state, action, post_state>.

Where both pre_state and post_state are in the form of page screenshots, which may include an auxiliary structure such as a UI tree or element location information.

Action describes a user interaction behavior, such as “click button X” or “input_text_Y” etc. Action specifically refers to structured behavior information which may include at least one of click position and control type.

During specific implementation, to avoid repeated exploration, a set may be used to record historical state-action combinations, generating a unique identifier based on pre_state+action, for example, obtaining a unique identifier by hashing UI element structures+action text encoding. During exploration, if the same identifier exists, no further exploration is conducted. During exploration, if no action is currently available, a fallback mechanism such as simulating navigate_back key is triggered.

In this embodiment, steps S201-S205 above represent a specific implementation of step S101 shown in FIG. 1 above. In this implementation, using a simulator to simulate running applications and interactive exploration based on DFS strategy can deeply and comprehensively mine all data triples in the application, effectively improving the comprehensiveness and accuracy of collected data triples.

S206: constructing an initial state transition graph by taking the first user interface state and the corresponding second user interface state in each data triple as nodes, and taking the action in each data triple as an edge from the corresponding first user interface state to the corresponding second user interface state;

S207: obtaining the state transition graph by merging nodes with same functionality in the initial state transition graph;

To structurally organize all exploration behaviors, in this embodiment, all data triples may be constructed into an initial state transition graph, where each node in the graph represents a UI state, which may be uniquely identified by a combination of a screen screenshot and UI elements. Each directed edge in the graph represents one user interaction behavior, i.e., an action, which can trigger the application to transition from pre_state to post_state.

Due to the potential issues of excessive nodes and structural redundancy in the initial state transition graph, in this embodiment, starting from the initial node in the initial state transition graph, a pre-trained multimodal large vision-language model can be used to perform semantic functionality understanding on nodes at each level successively, merging nodes with the same semantic functionality at the same level to obtain the state transition graph. This implementation may also be called a state clustering compression mechanism.

During specific implementation, starting from the initial node of the application, neighboring states at the same level can be grouped and clustered according to the same functionality. The large vision-language model may be used to perform semantic understanding of the screenshot, i.e., user interface state of each node to determine whether multiple nodes belong to the same type of functional page, such as multiple “Settings” pages with only subtle differences may be considered as pages of the same functionality. Then merge same-type page nodes into a virtual node, thereby reducing the graph structure scale and improving subsequent computational efficiency.

Steps S206-S207 above represent a specific implementation of step S102 shown in FIG. 1, through which the state transition graph of each application can be generated accurately and efficiently.

Optionally, when the initial state transition graph structure generated in step S206 is concise, step S207 can be omitted, and the initial state transition graph generated in step S206 can be directly used as the final state transition graph. Alternatively, without considering whether the initial state transition graph is concise or not, it can be directly used as the final state transition graph, which can also ensure obtaining a rich and comprehensive state transition graph.

S208: obtaining an interaction trajectory including at least one action starting from an initial node of the state transition graph;

Specifically, path extraction is performed on the constructed state transition graph to form an execution trajectory of the mobile agent, i.e., the interaction trajectory.

During path extraction, multiple reachable paths may be enumerated starting from the initial node in the state transition graph. To avoid getting stuck in UI loops such as Settings→back→Settings, during specific implementation, a loop avoidance strategy may be set up, letting each path maintain one visited set, and if a UI state has already appeared in the current path, that branch is skipped. Following this method, multiple interaction trajectories may be extracted from the state transition graph. Each interaction trajectory may include one, two, or multiple interactive actions. Moreover, in this embodiment, by starting from the initial node of the state transition graph, the obtained interaction trajectories are clearer and more convenient for mobile agent learning.

S209: obtaining a task objective of the interaction trajectory and semantic information of each action in the interaction trajectory by using a pre-trained multimodal large language model based on the interaction trajectory;

For example, specific implementation may include the following steps:
(1) Performing semantic understanding on each action in the interaction trajectory using the multimodal large language model to obtain semantic information of each action;

For example, the data triple corresponding to each action in the interaction trajectory may be obtained first; and then semantic understanding is performed on each action using the multimodal large language model based on the data triple corresponding to each action to obtain the semantic information of each action.

This step is used to implement semantic understanding of a single action in the interaction trajectory. Specifically, input each data triple <pre_state, action, post_state> in the interaction trajectory into the multimodal large language model, which outputs semantic information of the action through semantic analysis and understanding of screen screenshots corresponding to pre_state and post_state and action, specifically in the form of natural language action descriptions; for example: it can be “click the ‘Settings’ button in the upper right corner of the homepage” or “fill in the username in the input box and submit” etc.

Through this method, obtaining semantic information of each action can provide clearer behavioral labels for the mobile agent, enhancing the interpretability and generalization ability of its behavioral learning.
(2) Obtaining a triple sequence corresponding to the interaction trajectory;
(3) Performing semantic understanding on the triple sequence corresponding to the interaction trajectory using the multimodal large language model to obtain the task objective of the interaction trajectory.

In this embodiment, by extracting interface states and actions in the interaction trajectory in a sequential order, a triple sequence including multiple ordered data triples can be obtained. The multimodal large language model further performs abstract understanding on this triple sequence to generate a objective description of the overall task represented by this interaction trajectory, i.e., the task objective.

For example,
Input: multiple <pre_state, action, post_state> data triples in the triple sequence;
Output: the task objective in semantic description of this interaction trajectory, such as: “open APP and complete login process” or “enter settings interface to modify notification permissions” etc.

The capability of generating the task objective from the interaction trajectory in this embodiment can construct rich and diverse task objective-interaction trajectory sample pairs, becoming a core source of supervision signals for training mobile agents.

S210: generating training data based on the interaction trajectory, the task objective of the interaction trajectory, and semantic information of each action.

The training data obtained in this embodiment includes not only the interaction trajectory but also the task objective of the interaction trajectory and semantic information of each action in the interaction trajectory. The interaction trajectory may include at least two nodes and actions between any two adjacent nodes, with each node corresponding to a user interface state. The task objective of the interaction trajectory and semantic information of each action in the interaction trajectory can use natural language descriptions to explain the interaction trajectory, making it more convenient for mobile agent learning.

In this embodiment, through large language model capabilities, semantic understanding of each interactive action and the entire interaction trajectory can generate high-quality training data for mobile agent learning.

The method for generating training data of the mobile agent in this embodiment, by adopting the above solution, can automatically implement the generation of training data for the mobile agent without manual intervention, effectively improving the accuracy and efficiency of training data generation.

Moreover, in this embodiment, by running applications using a simulator and adopting DFS strategy for deep exploration, the quality and diversity of obtained data triples can be effectively improved, thereby effectively improving the quality and diversity of generated training data for the mobile agent, which in turn can effectively improve the training efficiency and generalization ability of the trained mobile agent.

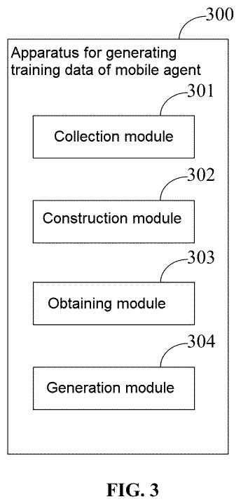

FIG. 3 is a schematic diagram according to a third embodiment of the present disclosure; as shown in FIG. 3, this embodiment provides an apparatus 300 for generating training data of a mobile agent, including:
a collection module 301, configured to collect multiple data triples representing interaction behaviors in an application; each of the data triples including a first user interface state, an action, and a second user interface state;
a construction module 302, configured to construct a state transition graph based on the multiple data triples;
an obtaining module 303, configured to obtain an interaction trajectory based on the state transition graph; and
a generation module 304, configured to generate training data of the mobile agent based on the interaction trajectory.

The implementation principle and technical effects of generating training data of a mobile agent through the modules of the apparatus 300 in this embodiment are the same as those in the above-related method embodiments, which can be referred to in detail in the above-related embodiments and will not be repeated here.

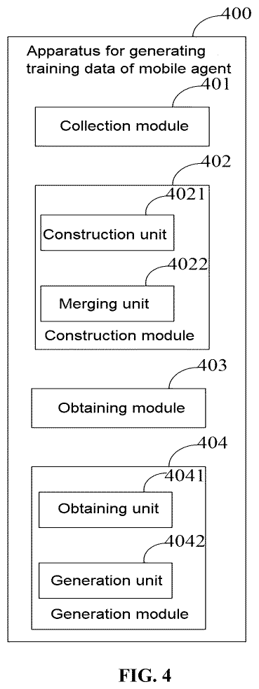

FIG. 4 is a schematic diagram according to a fourth embodiment of the present disclosure; the apparatus 400 for generating training data of a mobile agent in this embodiment, based on the technical solution shown in FIG. 3, further describes the technical solution of the present disclosure in more detail. As shown in FIG. 4, the apparatus 400 for generating training data of a mobile agent in this embodiment includes modules with the same names and functions as shown in FIG. 3: a collection module 401, a construction module 402, an obtaining module 403, and a generation module 404.

As shown in FIG. 4, in the apparatus 400 for generating training data of a mobile agent in this embodiment, the generation module 404 includes:
an obtaining unit 4041, configured to obtain a task objective of the interaction trajectory and semantic information of each action in the interaction trajectory by using a pre-trained multimodal large language model based on the interaction trajectory; and
a generation unit 4042, configured to generate training data based on the interaction trajectory, the task objective of the interaction trajectory, and semantic information of each action in the interaction trajectory.

Further optionally, in an embodiment of the present disclosure, the obtaining unit 4041 is configured to:
perform semantic understanding on each action in the interaction trajectory using the multimodal large language model to obtain semantic information of each action;
obtain a triple sequence corresponding to the interaction trajectory;
perform semantic understanding on the task objective of the interaction trajectory using the multimodal large language model based on the triple sequence corresponding to the interaction trajectory to obtain the task objective of the interaction trajectory.

Further optionally, in an embodiment of the present disclosure, the obtaining unit 4041 is configured to:
obtain the data triple corresponding to each action in the interaction trajectory;
perform semantic understanding on each action using the multimodal large language model based on the data triple corresponding to each action to obtain semantic information of each action.

Further optionally, in an embodiment of the present disclosure, the obtaining module 403 is configured to:
obtain the interaction trajectory including at least one action starting from an initial node of the state transition graph.

Further optionally, in an embodiment of the present disclosure, the collection module 401 is configured to:
run the application using a simulator;
explore interaction behaviors in the application using a depth-first search strategy to obtain multiple first user interface states in the application and a user interface semantic tree corresponding to each of the first user interface states;
parse the user interface semantic tree corresponding to each of the first user interface states to obtain interactive elements in each of the first user interface states;
obtain a corresponding second user interface state entered after executing an executable action by a corresponding interactive element in a page of each of the first user interface states;
obtain the multiple data triples representing interaction behaviors in the application based on each of the first user interface states, the executable action executed by the corresponding interactive element, and the corresponding second user interface state.

Further optionally, as shown in FIG. 4, in an embodiment of the present disclosure, the construction module 402 includes:
a construction unit 4021, configured to construct an initial state transition graph by taking the first user interface state and the corresponding second user interface state in each data triple as nodes, and taking the action in each data triple as an edge from the corresponding first user interface state to the corresponding second user interface state; and
a merging unit 4022, configured to obtain the state transition graph by merging nodes with same functionality in the initial state transition graph.

Further optionally, in an embodiment of the present disclosure, the merging unit 4022 is configured to:
start from an initial node in the initial state transition graph, perform semantic functionality understanding on nodes at each level using a pre-trained vision multimodal large language model, and merge nodes with same semantic functionality at the same level to obtain the state transition graph.

The implementation principle and technical effects of generating training data of a mobile agent through the modules of the apparatus 400 in this embodiment are the same as those in the above-related method embodiments, which can be referred to in detail in the above-related embodiments and will not be repeated here.

In the technical solution of the present disclosure, the acquisition, storage and application of user personal information involved all comply with relevant laws and regulations, and do not violate public order and good morals.

According to embodiments of the present disclosure, the present disclosure also provides an electronic device, a readable storage medium and a computer program product.

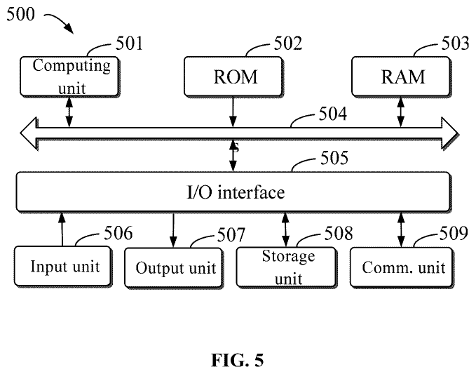

FIG. 5 shows a schematic block diagram of an example electronic device 500 that can be used to implement embodiments of the present disclosure. The electronic device is intended to represent various forms of digital computers, such as laptops, desktops, workstations, personal digital assistants, servers, blade servers, mainframes, and other suitable computers. The electronic device can also represent various forms of mobile devices, such as personal digital processors, cellular phones, smartphones, wearable devices, and other similar computing devices. The components shown here, their connections and relationships, and their functions are merely as examples, and are not intended to limit implementations of the disclosure described and/or claimed in this document.

As shown in FIG. 5, the device 500 includes a computing unit 501, which can execute various appropriate actions and processing according to computer programs stored in a read-only memory (ROM) 502 or loaded into a random access memory (RAM) 503 from a storage unit 508. Various programs and data needed for operation of the device 500 can also be stored in the RAM 503. The computing unit 501, the ROM 502, and the RAM 503 are connected to each other through a bus 504. An input/output (I/O) interface 505 is also connected to the bus 504.

Multiple components in the device 500 are connected to the I/O interface 505, including: an input unit 506, such as keyboard, mouse, etc.; an output unit 507, such as various types of displays, speakers, etc.; a storage unit 508, such as magnetic disks, optical disks, etc.; and a communication unit (comm. unit) 509, such as network cards, modems, wireless communication transceivers, etc. The communication unit 509 allows the device 500 to exchange information/data with other devices through computer networks such as the Internet and/or various telecommunication networks.

The computing unit 501 can be various general and/or special-purpose processing components with processing and computing capabilities. Some examples of the computing unit 501 include but are not limited to central processing units (CPU), graphics processing units (GPU), various specialized artificial intelligence (AI) computing chips, various computing units running machine learning model algorithms, digital signal processors (DSP), and any appropriate processors, controllers, microcontrollers, etc. The computing unit 501 executes the various methods and processes described above, such as the above-mentioned methods of the present disclosure. For example, in some embodiments, the above-mentioned methods of the present disclosure can be implemented as computer software programs that are tangibly included in machine-readable media, such as the storage unit 508. In some embodiments, part or all of the computer program can be loaded and/or installed onto the device 500 via the ROM 502 and/or the communication unit 509. When the computer program is loaded into the RAM 503 and executed by the computing unit 501, one or more steps of the above-mentioned methods of the present disclosure can be executed. Alternatively, in other embodiments, the computing unit 501 can be configured to execute the above-mentioned methods of the present disclosure through any other appropriate means (for example, through firmware).

Various implementations of the systems and techniques described herein can be realized in digital electronic circuitry systems, integrated circuit systems, field programmable gate arrays (FPGA), application specific integrated circuits (ASIC), application specific standard products (ASSP), system on chip systems (SOC), complex programmable logic devices (CPLD), computer hardware, firmware, software, and/or combinations of them. These various implementations can include: implementation in one or more computer programs that are executable and/or interpretable on a programmable system including at least one programmable processor, which can be special or general purpose, capable of receiving data and instructions from, and transmitting data and instructions to, a storage system, at least one input device, and at least one output device.

Program code for implementing the methods of the present disclosure can be written in any combination of one or more programming languages. These program codes can be provided to processors or controllers of general-purpose computers, special-purpose computers, or other programmable data processing apparatus, such that when the program code is executed by the processor or controller, the functions/operations specified in the flowcharts and/or block diagrams are implemented. The program code can be executed entirely on the machine, partly on the machine, partly on the machine as a standalone software package and partly on a remote machine, or entirely on the remote machine or server.

In the context of the present disclosure, a machine-readable medium can be a tangible medium that can contain or store a program for use by or in connection with an instruction execution system, apparatus, or device. The machine-readable medium can be a machine-readable signal medium or a machine-readable storage medium. The machine-readable medium can include, but is not limited to, electronic, magnetic, optical, electromagnetic, infrared, or semiconductor systems, apparatus or devices, or any suitable combination thereof. More specific examples of machine-readable storage media would include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

To provide interaction with a user, the systems and techniques described here can be implemented on a computer having a display device (e.g., a CRT (cathode ray tube) or LCD (liquid crystal display) monitor) for displaying information to the user, and a keyboard and pointing device (e.g., a mouse or trackball) by which the user can provide input to the computer. Other kinds of devices can be used to provide interaction with users; for example, feedback provided to the user can be any form of sensory feedback (e.g., vision feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a user computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include: local area networks (LAN), wide area networks (WAN), and the Internet.

Computer systems can include clients and servers. Clients and servers generally are remote from each other and typically interact through a communication network. The relationship between clients and servers is created by computer programs running on the respective computers and having a client-server relationship with each other. The server can be a cloud server, a server of a distributed system, or a server integrated with blockchain.

It should be understood that various forms of processes shown above can be used, with steps being reordered, added, or deleted. For example, the steps recorded in this disclosure can be executed in parallel, sequentially, or in different orders, as long as they can achieve the desired results of the technical solution disclosed in this disclosure, no limitations are imposed herein.

The above specific embodiments do not constitute limitations on the protection scope of the present disclosure. Those skilled in the art should understand that various modifications, combinations, sub-combinations and substitutions can be made according to design requirements and other factors. Any modifications, equivalent substitutions and improvements made within the spirit and principles of the present disclosure should be included in the protection scope of the present disclosure.

What is claimed is:

1. A method for generating training data of a mobile agent, comprising:
collecting multiple data triples representing interaction behaviors in an application; each of the data triples comprising a first user interface state, an action, and a second user interface state;
constructing a state transition graph based on the multiple data triples;
obtaining an interaction trajectory based on the state transition graph; and
generating training data of the mobile agent based on the interaction trajectory.

2. The method according to claim 1, wherein generating the training data of the mobile agent based on the interaction trajectory comprises:
obtaining a task objective of the interaction trajectory and semantic information of each action in the interaction trajectory by using a pre-trained multimodal large language model based on the interaction trajectory; and
generating the training data based on the interaction trajectory, the task objective of the interaction trajectory, and the semantic information of each action in the interaction trajectory.

3. The method according to claim 2, wherein obtaining the task objective of the interaction trajectory and the semantic information of each action in the interaction trajectory by using the pre-trained multimodal large language model based on the interaction trajectory comprises:
performing semantic understanding on each action in the interaction trajectory using the multimodal large language model to obtain the semantic information of each action;
obtaining a triple sequence corresponding to the interaction trajectory; and
performing semantic understanding on the triple sequence corresponding to the interaction trajectory using the multimodal large language model to obtain the task objective of the interaction trajectory.

4. The method according to claim 3, wherein performing semantic understanding on each action in the interaction trajectory using the multimodal large language model to obtain semantic information of each action comprises:
obtaining a data triple corresponding to each action in the interaction trajectory; and
performing semantic understanding on each action using the multimodal large language model based on the data triple corresponding to each action to obtain the semantic information of each action.

5. The method according to claim 1, wherein obtaining the interaction trajectory based on the state transition graph comprises:
obtaining the interaction trajectory comprising at least one action starting from an initial node of the state transition graph.

6. The method according to claim 1, wherein collecting the multiple data triples representing interaction behaviors in the application comprises:
running the application using a simulator;
exploring interaction behaviors in the application using a depth-first search strategy to obtain multiple first user interface states in the application and a user interface semantic tree corresponding to each of the first user interface states;
parsing the user interface semantic tree corresponding to each of the first user interface states to obtain interactive elements in each of the first user interface states;
obtaining a corresponding second user interface state entered after executing an executable action by a corresponding interactive element in a page of each of the first user interface states; and
obtaining the multiple data triples representing interaction behaviors in the application based on each of the first user interface states, the executable action executed by the corresponding interactive element, and the corresponding second user interface state.

7. The method according to claim 1, wherein constructing the state transition graph based on the multiple data triples comprises:
constructing an initial state transition graph by taking the first user interface state and the corresponding second user interface state in each of the data triples as nodes, and taking the action in each of the data triples as an edge from the corresponding first user interface state to the corresponding second user interface state; and
obtaining the state transition graph by merging nodes with same functionality in the initial state transition graph.

8. The method according to claim 7, wherein obtaining the state transition graph by merging nodes with same functionality in the initial state transition graph comprises:
starting from an initial node in the initial state transition graph, performing semantic functionality understanding on nodes at each level using a pre-trained multimodal large vision-language model, and merging nodes with same semantic functionality at the same level to obtain the state transition graph.

9. An electronic device, comprising:
at least one processor; and
a memory communicatively connected to the at least one processor; wherein
the memory stores instructions executable by the at least one processor to cause the at least one processor to perform a method for generating training data of a mobile agent which comprises:
collecting multiple data triples representing interaction behaviors in an application; each of the data triples comprising a first user interface state, an action, and a second user interface state;
constructing a state transition graph based on the multiple data triples;
obtaining an interaction trajectory based on the state transition graph; and
generating training data of the mobile agent based on the interaction trajectory.

10. The electronic device according to claim 9, wherein generating the training data of the mobile agent based on the interaction trajectory comprises:
obtaining a task objective of the interaction trajectory and semantic information of each action in the interaction trajectory by using a pre-trained multimodal large language model based on the interaction trajectory; and
generating the training data based on the interaction trajectory, the task objective of the interaction trajectory, and the semantic information of each action in the interaction trajectory.

11. The electronic device according to claim 10, wherein obtaining the task objective of the interaction trajectory and the semantic information of each action in the interaction trajectory by using the pre-trained multimodal large language model based on the interaction trajectory comprises:
performing semantic understanding on each action in the interaction trajectory using the multimodal large language model to obtain the semantic information of each action;
obtaining a triple sequence corresponding to the interaction trajectory; and
performing semantic understanding on the triple sequence corresponding to the interaction trajectory using the multimodal large language model to obtain the task objective of the interaction trajectory.

12. The electronic device according to claim 11, wherein performing semantic understanding on each action in the interaction trajectory using the multimodal large language model to obtain semantic information of each action comprises:
obtaining a data triple corresponding to each action in the interaction trajectory; and
performing semantic understanding on each action using the multimodal large language model based on the data triple corresponding to each action to obtain the semantic information of each action.

13. The electronic device according to claim 9, wherein obtaining the interaction trajectory based on the state transition graph comprises:
obtaining the interaction trajectory comprising at least one action starting from an initial node of the state transition graph.

14. The electronic device according to claim 9, wherein collecting the multiple data triples representing interaction behaviors in the application comprises:
running the application using a simulator;
exploring interaction behaviors in the application using a depth-first search strategy to obtain multiple first user interface states in the application and a user interface semantic tree corresponding to each of the first user interface states;
parsing the user interface semantic tree corresponding to each of the first user interface states to obtain interactive elements in each of the first user interface states;
obtaining a corresponding second user interface state entered after executing an executable action by a corresponding interactive element in a page of each of the first user interface states; and
obtaining the multiple data triples representing interaction behaviors in the application based on each of the first user interface states, the executable action executed by the corresponding interactive element, and the corresponding second user interface state.

15. The electronic device according to claim 9, wherein constructing the state transition graph based on the multiple data triples comprises:
constructing an initial state transition graph by taking the first user interface state and the corresponding second user interface state in each of the data triples as nodes, and taking the action in each of the data triples as an edge from the corresponding first user interface state to the corresponding second user interface state; and
obtaining the state transition graph by merging nodes with same functionality in the initial state transition graph.

16. The electronic device according to claim 15, wherein obtaining the state transition graph by merging nodes with same functionality in the initial state transition graph comprises:
starting from an initial node in the initial state transition graph, performing semantic functionality understanding on nodes at each level using a pre-trained multimodal large vision-language model, and merging nodes with same semantic functionality at the same level to obtain the state transition graph.

17. A non-transitory computer-readable storage medium storing computer instructions for causing a computer to perform a method for generating training data of a mobile agent which comprises:
collecting multiple data triples representing interaction behaviors in an application; each of the data triples comprising a first user interface state, an action, and a second user interface state;
constructing a state transition graph based on the multiple data triples;
obtaining an interaction trajectory based on the state transition graph; and
generating training data of the mobile agent based on the interaction trajectory.

18. The storage medium according to claim 17, wherein generating the training data of the mobile agent based on the interaction trajectory comprises:
obtaining a task objective of the interaction trajectory and semantic information of each action in the interaction trajectory by using a pre-trained multimodal large language model based on the interaction trajectory; and
generating the training data based on the interaction trajectory, the task objective of the interaction trajectory, and the semantic information of each action in the interaction trajectory.

19. The storage medium according to claim 18, wherein obtaining the task objective of the interaction trajectory and the semantic information of each action in the interaction trajectory by using the pre-trained multimodal large language model based on the interaction trajectory comprises:
performing semantic understanding on each action in the interaction trajectory using the multimodal large language model to obtain the semantic information of each action;
obtaining a triple sequence corresponding to the interaction trajectory; and
performing semantic understanding on the triple sequence corresponding to the interaction trajectory using the multimodal large language model to obtain the task objective of the interaction trajectory.

20. The storage medium according to claim 19, wherein performing semantic understanding on each action in the interaction trajectory using the multimodal large language model to obtain semantic information of each action comprises:
obtaining a data triple corresponding to each action in the interaction trajectory; and
performing semantic understanding on each action using the multimodal large language model based on the data triple corresponding to each action to obtain the semantic information of each action.
